(19) United States
(12) Patent Application Publication
(10) Pub. No.: US 2025/0235381 A1
(43) Pub. Date: Jul. 24, 2025

(54) MEDICINE REFRIGERATION CUP

(71) Applicant: Zhejiang Sunclose Technology CO., LTD., Jinhua (CN)

(72) Inventors: HUAJIAN ZHANG, Jinhua (CN); JINGPING LI, Jinhua (CN)

(21) Appl. No.: 19/001,482

(22) Filed: Dec. 25, 2024

Related U.S. Application Data
(63) Continuation of application No. PCT/CN2024/075252, filed on Feb. 1, 2024.

(30) Foreign Application Priority Data
Jan. 24, 2024 (CN) 202420169854.1

(51) Int. Cl. A61J 1/14

(52) U.S. Cl. CPC A61J 1/1412; A61J 1/1468; A61J 2200/44; A61J 2200/50

(57) ABSTRACT

A medicine refrigeration cup is provided, which includes a cup body and a refrigeration device. The cup body includes a cup main body with a medicine compartment and a cup cover configured to close the medicine compartment. The cup cover includes a first cover body and a second cover body. The second cover body includes an installation plate, a first and a second ring walls. The first ring wall surrounds the first cover body to form a heat dissipation chamber, the second ring wall is detachably provided on the cup main body. The refrigeration device includes a semiconductor refrigeration chip with a cold end face and a hot end face, a cold conduction device configured to be extended into the medicine compartment, a heat conduction member and a heat dissipation fan provided in the heat dissipation chamber. The heat conduction member is connected to the hot end face.

### CROSS-REFERENCE TO RELATED APPLICATIONS

This application is a continuation of International Application No. PCT/CN2024/075252, filed on Feb. 1, 2024, which claims priority to Chinese Patent Application No. 202420169854.1, filed with the China National Intellectual Property Administration on Jan. 24, 2024. Both of which are hereby incorporated by reference in their entireties.

### TECHNICAL FIELD

The present disclosure relates to the field of medicine technologies, and in particular, to a medicine refrigeration cup.

### BACKGROUND

CN202320902531.4 discloses a miniature biological sample transport cup, which include a cold storage cup, a top of the cold storage cup is equipped with a liquid filling port, and the cold storage cup is equipped with a refrigerant liquid filled from the liquid filling port; an outer side of the liquid filling port is equipped with a sample fixing hole, and the cold storage cup is connected with a cold storage cup cover through threaded sealing above the cold storage cup; the cold storage cup is set in an outer cup body, and a top of the outer cup body is connected with an insulation cover or a semiconductor refrigeration device, the semiconductor refrigeration device can cool and maintain the cold storage cup. In this scheme, the cold end temperature of the semiconductor refrigeration device is rapidly decreased. The cold end, namely, a sleeve, is inserted into a periphery of the cold storage cup to maintain the temperature of the cold storage cup. The sleeve is connected to a base, and the base is suitable for exposure to the environment. Therefore, the semiconductor refrigeration device needs to increase its power to maintain a heat exchange between the sleeve and the environment through the base or decrease the cooling effect of the cold storage cup.

### SUMMARY

The present disclosure provides a medicine refrigeration cup to meet needs of a user, in response to the shortcomings of the existing technology.

To achieve the above objectives, the present disclosure provides a medicine refrigeration cup, including:
a cup body including a cup main body with a medicine compartment and a cup cover configured to close the medicine compartment; the cup cover includes a first cover body and a second cover body; the second cover body includes an installation plate, a first ring wall and a second ring wall that are provided on two sides of the installation plate; the first ring wall surrounds the first cover body to form a heat dissipation chamber, and the second ring wall is detachably provided on the cup main body,
a refrigeration device including a semiconductor refrigeration chip with a cold end face and a hot end face, a cold conduction device configured to be extended into the medicine compartment, a heat conduction member and a heat dissipation fan provided in the heat dissipation chamber; where the heat conduction member is connected to the hot end face, and the heat dissipation fan is provided above the heat conduction member,
where the installation plate includes an installation area configured to connect the cold conduction device, and an isolation area configured to separate the second ring wall from the cold conduction device; the installation area is provided with an opening area configured to connect the cold end face with the cold conduction device.

In some embodiments of the present disclosure, the cold conduction device includes installation end faces, and the installation area is composed of the installation plate that is closely adhered to the installation end faces; where the installation plate and the installation end faces define the isolation area,
an area of the installation plate is defined as a first area, an area of the installation area is defined as a second area, a difference between the first area and the second area is an area of the isolation area, and the area of the isolation area is not less than 0.5 square centimeters; or
the installation end faces are all circular and define a circular isolation area; a radius of the installation plate is defined as a first radius, and a radius of the installation area is defined as a second radius; a difference between the first radius and the second radius is defined as a diameter of the circular isolation area, and the diameter of the circular isolation area is 0.05 to 0.5 times the first radius.

In some embodiments of the present disclosure, at least one of the following conditions is met:
a working voltage of the refrigeration device is not exceeded 24V;
the diameter of the circular isolation area is not less than 1 mm;
the cold conduction device has a structure of a hollow cylindrical structure, a chain structure, a strip structure, a column structure, or a mesh structure.

In some embodiments of the present disclosure, the cold conduction device includes an integrated installation end, and the installed end is provided with the installation end faces,
where the installation end faces are bonded or injection molded with the installation plate, or
the installation end is a solid structure, and the installation end is fixedly connected to the installation area through a plurality of bolts that are vertically arranged.

In some embodiments of the present disclosure, the cold conduction device includes a detachable installation end, the installation end is provided with the installation end faces, and the installation end is connected to the installation area through integral injection molding.

In some embodiments of the present disclosure, the second cover body further includes an inner ring wall extending downward from the isolation area, the inner ring wall is coaxially arranged with the second ring wall and surrounds to form an isolation groove; the cup main body includes a cup mouth with external threads, an inner surface of the second ring wall is provided with internal threads; the cup mouth is configured to be extended into the isolation groove and be connected to the second ring wall by threaded; and the isolation groove is configured to provide with a sealing ring and/or insulation material.

In some embodiments of the present disclosure, the heat conduction member includes a thermal conductive cavity and a plurality of thermal conductive fins that are radially arranged; the thermal conductive cavity includes a circular cavity bottom configured to contact the hot end face, the thermal conductive fins include first fin ends and second fin ends, the first fin ends surround the thermal conductive cavity to form a guide channel, and the heat dissipation fan is coaxially arranged with the thermal conductive cavity.

In some embodiments of the present disclosure, the first cover includes an air inlet provided on an upper surface of the first cover and an air outlet provided on a circumferential outer surface of the first cover; the air outlet is extended vertically and is arranged corresponding to a gap between two of the second fin ends; the heat dissipation fan is configured to drive airflow to converge into the guide channel from the air inlet, and then disperse and flow out of the air outlet through a gap between the thermal conductive fins.

In some embodiments of the present disclosure, the first cover includes a plurality of air inlets provided on the circumferential outer surface of the first cover and a plurality of air outlets provided on the upper surface of the first cover, where the air inlets are extended vertically and are arranged corresponding to the gap between two of the second fin ends; the heat dissipation fan is configured to drive the airflow to converge into the guide channel through the gap between the thermal conductive fins from the air inlets and then flow out of the air outlets.

In some embodiments of the present disclosure, the first cover includes a plurality of air outlets and a plurality of air inlets that are provided on the circumferential outer surface of the first cover; the air outlets and the air inlets are extended vertically; the air outlets are provided above or below the air outlets; the air outlets or the air inlets are arranged corresponding to the gap between two of the second fin ends; correspondingly, the heat dissipation fan is configured to drive the airflow to coverage into the guide channel through the gap between the thermal conductive fins from the air inlets and then flow out of the air outlets, or the heat dissipation fan is configured to drive the airflow to converge into the guide channel from the air inlets and then flow out form the air outlets through the gap of the thermal conductive fins.

In some embodiments of the present disclosure, the heat dissipation fan is provided in a space above the first cover, and the heat conduction fins include a plurality of first heat conduction fins and a plurality of second heat conduction fins configured to fix the heat conduction member to the installation plate by screws, the second heat conduction fins are uniformly spaced apart from the first heat conduction fins.

In some embodiments of the present disclosure, second fin ends of the first thermal conductive fins bifurcate to form a plurality of unit fins, and second fin ends of the second thermal conductive fins are provided with an installation groove configured to accommodate the screws;
the installation plate includes an installation column aligned with the installation groove, and the installation column is threaded with the screws.

In some embodiments of the present disclosure: the medicine refrigeration cup further includes a screen that is tilted provided at an intersection of the upper surface of the first cover and a circumferential surface of the first cover, and a control circuit board provided around the heat dissipation fan; where the control circuit board is electrically connected to the screen, the semiconductor refrigeration chip and the heat dissipation fan; the screen is configured to display a working state of the refrigeration device and/or to control start and stop of the refrigeration device;
the control circuit further includes a power supply interface, and the power supply interface is configured to be directly powered supply from an external power source, or power supply for a battery in the heat dissipation chamber by the external power source.

The beneficial effects of the present disclosure are as follow.

By providing the isolation area to avoid a direct contact or excessive proximity between the cold conduction device and the second ring wall, a heat transfer efficiency between the cold conduction device and heat in the environment can be reduced, a cooling effect of the refrigeration device can be improved, and energy consumption can be reduced.

### BRIEF DESCRIPTION OF DRAWINGS

FIG. 1 is a schematic structural diagram of a medicine refrigeration cup provided by the present disclosure.

FIG. 2 is an exploded schematic diagram of the medicine refrigeration cup provided by the present disclosure.

FIG. 3 is a schematic sectional view of the medicine refrigeration cup provided by the present disclosure.

FIG. 4 is an enlarged schematic diagram of a partial area in FIG. 3.

FIG. 5 is a schematic structural diagram of a second cover body provided by the present disclosure.

FIG. 6 is a schematic structural diagram of a heat conduction member provided by the present disclosure.

Numeral reference: cup main body 101, cup cover 102, medicine compartment 103, first cover body 104, second cover body 105, installation plate 106, first ring wall 107, second ring wall 108, semiconductor refrigeration chip 109, cold conduction device 110, heat dissipation chamber 111, heat conduction member 112, heat dissipation fan 113, installation area 114, isolation area 115, opening area 116, installation end 117, inner ring wall 118, isolation groove 119, cup mouth 120, sealing ring 121, thermal conductive cavity 122, first fin end 123, second fin end 124, air outlet 125, air inlet 126, first heat conduction fin 127, second heat conduction fin 128, unit fin 129, installation groove 130, installation column 131, screen 132, control circuit board 133, power supply interface 134.

### DESCRIPTION OF EMBODIMENTS

In order to clarify the purpose, technical solution, and advantages of the present disclosure, a detailed description of the present disclosure will be provided below in combination with the accompanying drawings and specific embodiments.

Here, it should be noted that in order to avoid blurring the present disclosure due to unnecessary details, only the structures and/or processing steps closely related to the solution of the present disclosure are shown in the accompanying drawings, and other details that are not closely related to the present disclosure are omitted.

Besides that, it should be noted that terms “including”, “having”, or any other variation thereof are intended to encompass non-exclusive inclusion, such that a process, method, item, or device that includes a series of elements not only includes those elements, but also includes other elements that are not explicitly listed or are inherent to such a process, method, item, or device.

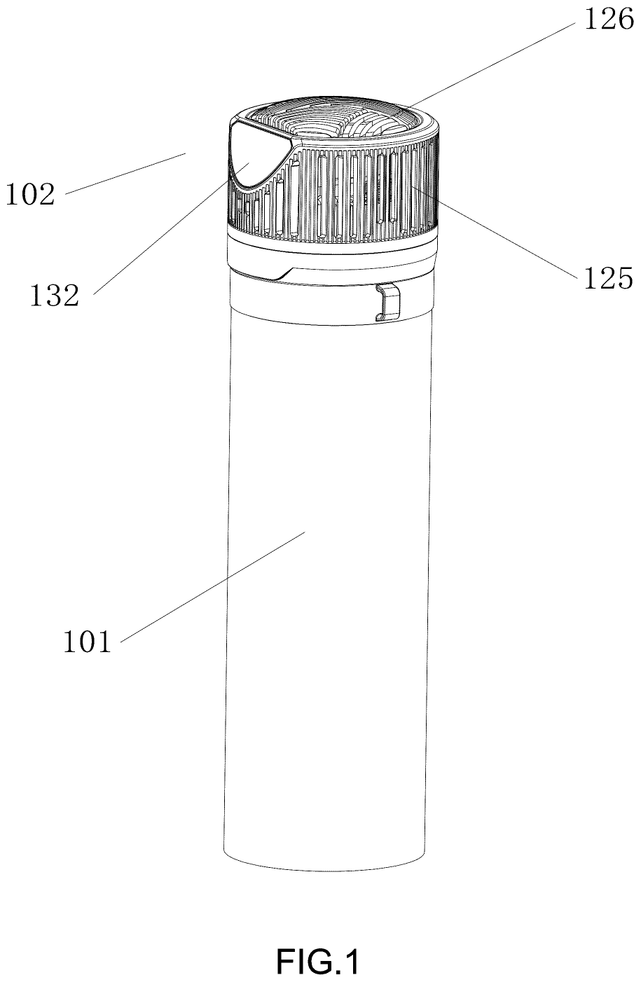

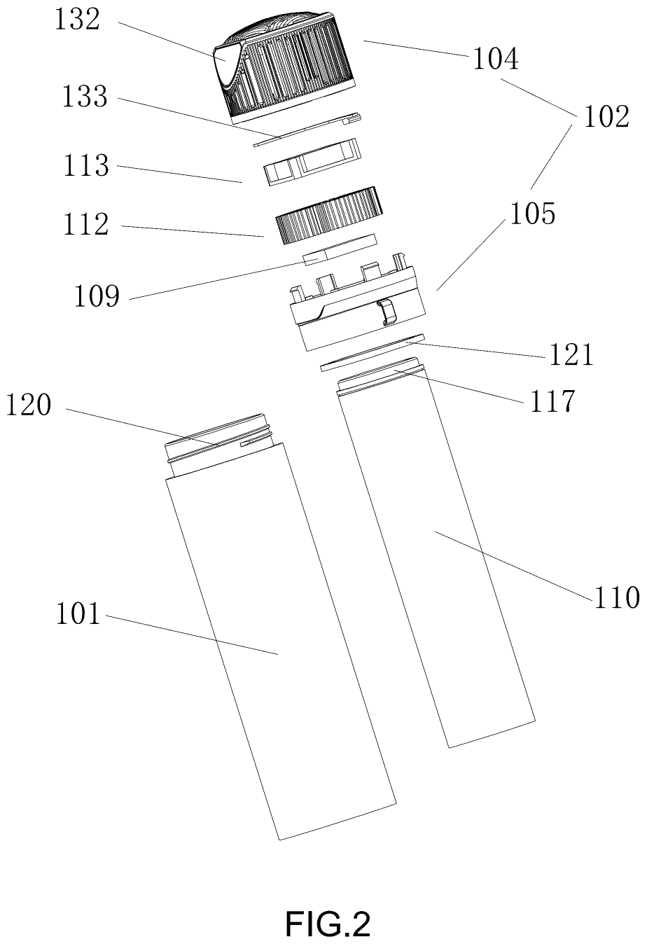

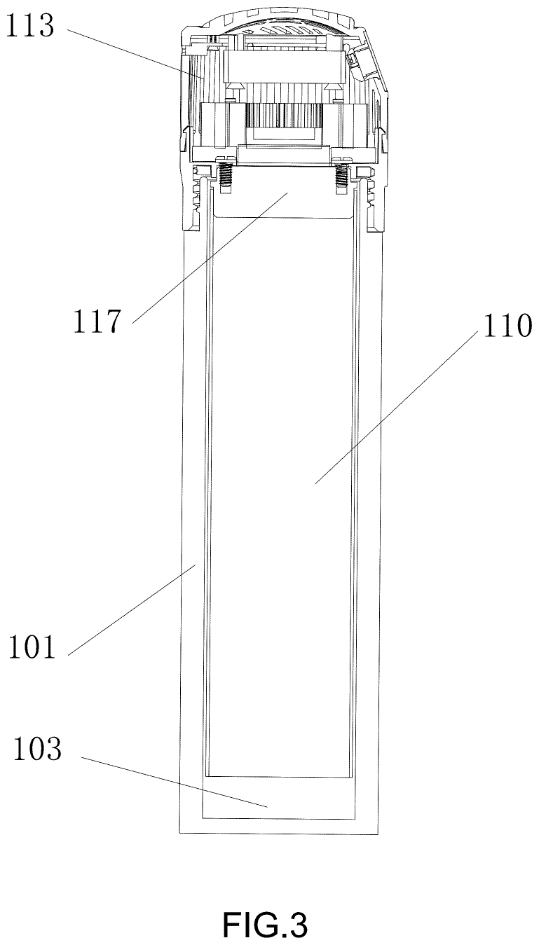

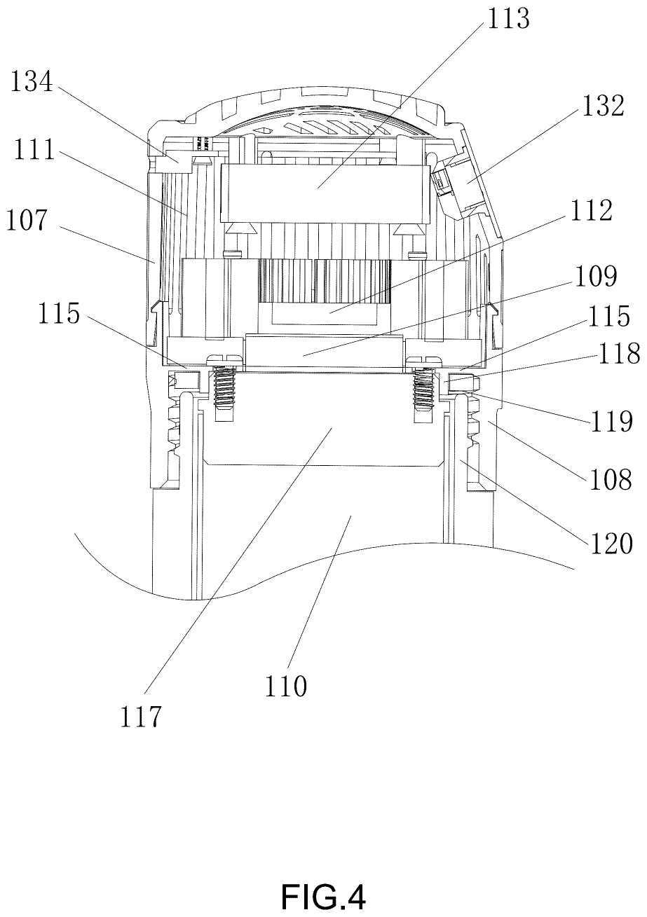

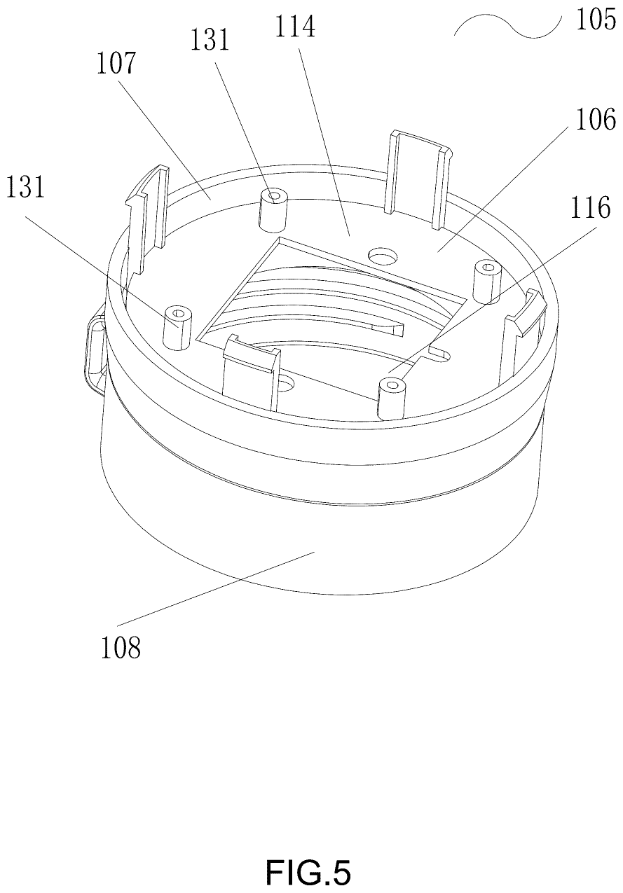

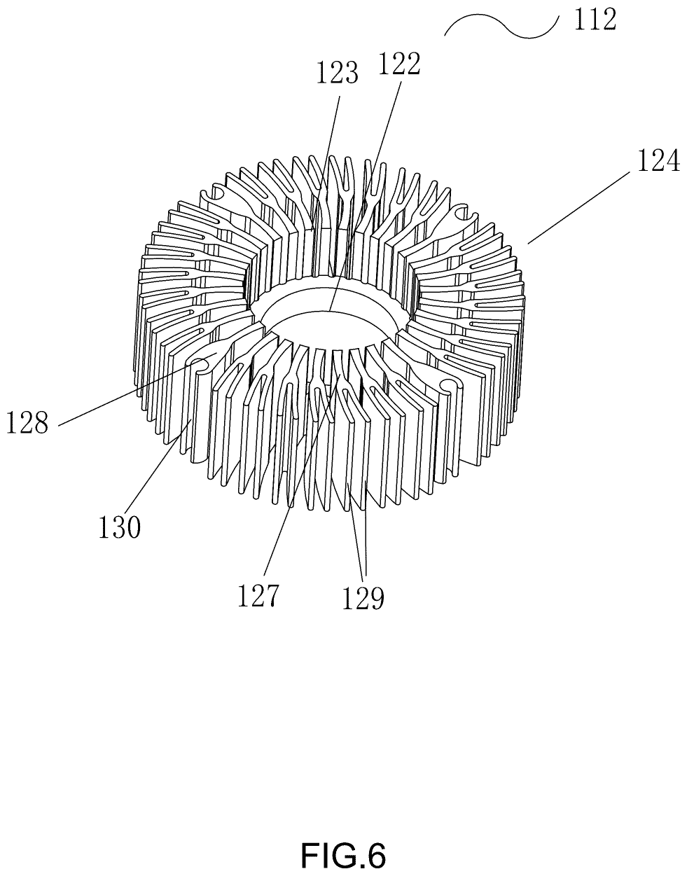

As shown in FIGS. 1-6, a medicine refrigeration cup includes a cup body and a refrigeration device. The cup body includes a cup main body 101 with a medicine compartment 103 and a cup cover 102 configured to close the medicine compartment 103. The cup cover 102 includes a first cover body 104 and a second cover body 105. The second cover body 105 includes an installation plate 106, a first ring wall 107 and a second ring wall 108 that are provided on an upper side and a lower side of the installation plate 106. The first ring wall 107 surrounds the first cover body 104 to form a heat dissipation chamber 111, and the second ring wall 108 is configured to be detachably provided on the cup main body 101. The refrigeration device includes a semiconductor refrigeration chip 109 with a cold end face and a hot end face, a cold conduction device 110 configured to be extended into the medicine compartment 103, a heat conduction member 112 and a heat dissipation fan 113 provided in the heat dissipation chamber 111. The heat conduction member 112 is configured to connect to the hot end face, and the heat dissipation fan 113 is provided above the heat conduction member 112. The installation plate 106 includes an installation area 114 configured to connect the cold conduction device 110 and an isolation area 115 configured to separate the second ring wall 108 from the cold conduction device 110. The installation area 114 is provided with an opening area 116 configured to contact the cold end face with the cold conduction device 110. A working voltage of the refrigeration device is 5V. By providing the isolation area 115, the refrigeration device can maintain a stable low-temperature environment in the medicine compartment 103 even at lower working voltages. At the same time, it can extend the working time of the medicine refrigeration cup, save energy and reduce consumption, reduce charging times, and meet the medicine storage needs of a user during a long-distance travel.

In this embodiment, the cold conduction device 110 includes an integrated installation end 117 and a hollow cylindrical structure extending downward from the installation end 117. It can be understood that the cold conduction device can further include a chain structure, strip structure, column structure, or mesh structure extending downward from the installation end 117, that is, a shape of the cold conduction device 110 should not make a limitation. The installation end 117 is provided with an installation end 117 face, and the installation area 114 is composed of the installation plate 106 that is closely adhered to the installation end 117 face. The installation plate 106 and the installation end 117 face are both circular and cooperate to define a circular isolation area 115. A radius of the installation plate 106 is defined as a first radius, a radius of the installation area 114 is defined as a second radius, and a difference between the first radius and the second radius is defined as a diameter of the circular isolation area 115. The diameter of the circular isolation area 115 is 4 mm, which is 0.25 times the first radius. in an implementation mode, the installation end 117 is a solid structure, and the installation end 117 is fixedly connected to the installation area 114 through a plurality of bolts that are vertically arranged.

In some other implementation modes, the isolation area 115 may also be square, an area of the installation plate is defined as a first area, an area of the installation area is defined as a second area, a difference between the first area and the second area is defined as an area of the isolation area, and the area of the isolation area is 1.5 square centimeters.

In this embodiment, the second cover body 105 further includes an inner ring wall 118 extending downward from the isolation area 115. The inner ring wall 118 is coaxially arranged with the second ring wall 108 and surrounds to form an isolation groove 119. The cup main body 101 includes a cup mouth 120 with external threads, an inner surface of the second ring wall 108 is provided with internal threads. The cup mouth 120 is configured to be extended into the isolation groove 119 and be connected to the second ring wall 108 by threads. The isolation groove 119 is configured to provide a sealing ring 121.

In this embodiment, the heat conduction member 112 includes a thermal conductive cavity 122 and a plurality of thermal conductive fins that are radially arranged. The thermal conductive cavity 122 includes a circular cavity bottom configured to contact the hot end face. The thermal conductive fins include first fin ends 123 and second fin ends 124. The first fin ends 123 surround the thermal conductive cavity 122 to form a guide channel. The heat dissipation fan 113 is a radial fan and is coaxially arranged with the thermal conductive cavity 122. The first cover body 104 includes an air outlet 125 provided on an outer surface of the first cover body 104 and an air inlet 126 provided on an upper surface of the first cover body 104. The air outlet 125 is extended vertically and is arranged corresponding to a gap between two of the second fin ends 124. The heat dissipation fan 113 is configured to drive airflow to converge into the guide channel from the air inlet 126, and then disperse and flow out of the air outlet 125 through a gap between the thermal conductive fins.

In this embodiment, the heat dissipation fan 113 is provided in a space above the first cover body 104, and the thermal conductive fins include a plurality of first heat conduction fins 127 and a plurality of second heat conduction fins 128 configured to fix the heat conduction member 112 to the installation plate 106 by screws. The second heat conduction fins 128 are uniformly spaced apart from the first heat conduction fins 127. Second fin ends 124 of the first heat conduction fins 127 bifurcate to form a plurality of unit fins 129, and second fin ends 124 of the second heat conduction fins 128 are provided with an installation groove 130 configured to accommodate the screws. The installation plate 106 includes an installation column 131 aligned with the installation groove 130, and the installation column 131 is threaded with the screws.

In this embodiment, the medicine refrigeration cup further includes a screen 132 that is titled provided at an intersection of the upper surface of the first cover body 104 and a circumferential surface of the first cover body 104, and a control circuit board 13 provided around the heat dissipation fan 113. The control circuit board 133 is electrically connected to the screen 132, the semiconductor refrigeration chip 109 and the heat dissipation fan 113. The screen 132 is configured to display a working state of the refrigeration device and control start and stop of the refrigeration device. The control circuit further includes a power supply interface 134, and the power supply interface 134 is configured to be directly powered supply from an external power source or power supply for a battery in the heat dissipation chamber 111 by the external power source.

The above embodiments are only used to illustrate the technical solution of the present disclosure and not to limit it. Although the present disclosure has been described in detail with reference to the preferred embodiments, those skilled in the art should understand that the technical solution of the present disclosure can be modified or equivalently replaced without departing from the spirit and scope of the technical solution of the present disclosure.

What is claimed is:

1. A medicine refrigeration cup, comprising:
a cup body comprising a cup main body with a medicine compartment and a cup cover configured to close the medicine compartment; the cup cover comprises a first cover body and a second cover body; the second cover body comprises an installation plate, a first ring wall and a second ring wall that are provided on two sides of the installation plate; the first ring wall surrounds the first cover body to form a heat dissipation chamber, and the second ring wall is detachably provided on the cup main body,
a refrigeration device comprising a semiconductor refrigeration chip with a cold end face and a hot end face, a cold conduction device configured to be extended into the medicine compartment, a heat conduction member and a heat dissipation fan provided in the heat dissipation chamber; wherein the heat conduction member is connected to the hot end face, and the heat dissipation fan is provided above the heat conduction member,
wherein the installation plate comprises an installation area configured to connect the cold conduction device, and an isolation area configured to separate the second ring wall from the cold conduction device; the installation area is provided with an opening area configured to connect the cold end face with the cold conduction device.

2. The medicine refrigeration cup according to claim 1, wherein the cold conduction device comprises installation end faces, and the installation area is composed of the installation plate that is closely adhered to the installation end faces; wherein the installation plate and the installation end faces define the isolation area,
an area of the installation plate is defined as a first area, an area of the installation area is defined as a second area, a difference between the first area and the second area is an area of the isolation area, and the area of the isolation area is not less than 0.5 square centimeters; or
the installation end faces are all circular and define a circular isolation area; a radius of the installation plate is defined as a first radius, and a radius of the installation area is defined as a second radius; a difference between the first radius and the second radius is defined as a diameter of the circular isolation area, and the diameter of the circular isolation area is 0.05 to 0.5 times the first radius.

3. The medicine refrigeration cup according to claim 2, wherein at least one of the following conditions is met:
a working voltage of the refrigeration device is not exceeded 24V;
the diameter of the circular isolation area is not less than 1 mm;
the cold conduction device has a structure of a hollow cylindrical structure, a chain structure, a strip structure, a column structure, or a mesh structure.

4. The medicine refrigeration cup according to claim 2, wherein the cold conduction device comprises an integrated installation end, and the installed end is provided with the installation end faces,
wherein the installation end faces are bonded or injection molded with the installation plate, or
the installation end is a solid structure, and the installation end is fixedly connected to the installation area through a plurality of bolts that are vertically arranged.

5. The medicine refrigeration cup according to claim 2, wherein the cold conduction device comprises a detachable installation end, the installation end is provided with the installation end faces, and the installation end is connected to the installation area through integral injection molding.

6. The medicine refrigeration cup according to claim 5, wherein the heat conduction member comprises a thermal conductive cavity and a plurality of thermal conductive fins that are radially arranged;
the thermal conductive cavity comprises a circular cavity bottom configured to contact the hot end face, the thermal conductive fins comprise first fin ends and second fin ends, the first fin ends surround the thermal conductive cavity to form a guide channel, and the heat dissipation fan is coaxially arranged with the thermal conductive cavity.

7. The medicine refrigeration cup according to claim 6, wherein the first cover comprises an air inlet provided on an upper surface of the first cover and an air outlet provided on a circumferential outer surface of the first cover; the air outlet is extended vertically and is arranged corresponding to a gap between two of the second fin ends; the heat dissipation fan is configured to drive airflow to converge into the guide channel from the air inlet, and then disperse and flow out of the air outlet through a gap between the thermal conductive fins; or
the first cover comprises a plurality of air inlets provided on the circumferential outer surface of the first cover and a plurality of air outlets provided on the upper surface of the first cover, wherein the air inlets are extended vertically and are arranged corresponding to the gap between two of the second fin ends; the heat dissipation fan is configured to drive the airflow to converge into the guide channel through the gap between the thermal conductive fins from the air inlets and then flow out of the air outlets; or
the first cover comprises a plurality of air outlets and a plurality of air inlets that are provided on the circumferential outer surface of the first cover; the air outlets and the air inlets are extended vertically; the air outlets are provided above or below the air outlets; the air outlets or the air inlets are arranged corresponding to the gap between two of the second fin ends; correspondingly, the heat dissipation fan is configured to drive the airflow to coverage into the guide channel through the gap between the thermal conductive fins from the air inlets and then flow out of the air outlets, or the heat dissipation fan is configured to drive the airflow to converge into the guide channel from the air inlets and then flow out form the air outlets through the gap of the thermal conductive fins.

8. The medicine refrigeration cup according to claim 7, wherein the heat dissipation fan is provided in a space above the first cover, and the heat conduction fins comprise a plurality of first heat conduction fins and a plurality of second heat conduction fins configured to fix the heat conduction member to the installation plate by screws,
the second heat conduction fins are uniformly spaced apart from the first heat conduction fins.

9. The medicine refrigeration cup according to claim 8, wherein second fin ends of the first thermal conductive fins bifurcate to form a plurality of unit fins, and second fin ends of the second thermal conductive fins are provided with an installation groove configured to accommodate the screws;
the installation plate comprises an installation column aligned with the installation groove, and the installation column is threaded with the screws.

10. The medicine refrigeration cup according to claim 9, further comprising:
a screen that is tilted provided at an intersection of the upper surface of the first cover and a circumferential surface of the first cover,
a control circuit board provided around the heat dissipation fan,
wherein the control circuit board is electrically connected to the screen, the semiconductor refrigeration chip and the heat dissipation fan; the screen is configured to display a working state of the refrigeration device and/or to control start and stop of the refrigeration device;
the control circuit further comprises a power supply interface, and the power supply interface is configured to be directly powered supply from an external power source, or power supply for a battery in the heat dissipation chamber by the external power source.

11. The medicine refrigeration cup according to claim 1, wherein the second cover body further comprises an inner ring wall extending downward from the isolation area, the inner ring wall is coaxially arranged with the second ring wall and surrounds to form an isolation groove; the cup main body comprises a cup mouth with external threads, an inner surface of the second ring wall is provided with internal threads;
the cup mouth is configured to be extended into the isolation groove and threaded connect with the second ring wall; and the isolation groove is configured to provide with a sealing ring and/or insulation material.
